(19) United States
(12) Patent Application Publication
(10) Pub. No.: US 2015/0081345 A1
(43) Pub. Date: Mar. 19, 2015

(54) ASSET COLLECTIVE REDIRECTION LEVERAGE MULTIPLIER PLATFORM APPARATUSES, METHODS AND SYSYTEMS

(71) Applicant: DARWIN & DAVINCI, UNLTD., LLC, MILL NECK, NY (US)

(72) Inventor: Robert WALLACH, Mill Neck, NY (US)

(21) Appl. No.: 14/489,355

(22) Filed: Sep. 17, 2014

Related U.S. Application Data
(60) Provisional application No. 61/879,106, filed on Sep. 17, 2013.

(51) Int. Cl. G06Q 40/08

(52) U.S. Cl. CPC G06Q 40/08
USPC 705/4

(57) ABSTRACT

The ASSET COLLECTIVE REDIRECTION LEVERAGE MULTIPLIER PLATFORM APPARATUSES, METHODS AND SYSTEMS (“ACRLMP”) provide a financial instrument management platform facilitating issuance, transaction, interest payment, and/or analytics of a municipality-based liquidity instrument from municipalities, investors, and sponsors.

### PRIORITY

This application is a non-provisional of, and claims priority under 35 U.S.C. 119 to U.S. provisional application Ser. No. 61/879.106, filed Sep. 17, 2013, entitled “Municipality-Based Liquuidity Instrument Management Apparatuses, Methods and Systems,” which is herein expressly incorporated by reference.

This application for letters patent discloses and describes various novel innovations and inventive aspects of ASSET COLLECTIVE REDIRECTION LEVERAGE MULTIPLIER PLATFORM APPARATUSES, METHODS AND SYSTEMS technology (hereinafter “ACRLMP”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present invention is directed generally to apparatuses, methods, and systems of municipal debt management, and more particularly, to ASSET COLLECTIVE REDIRECTION LEVERAGE MULTIPLIER PLATFORM APPARATUSES, METHODS AND SYSTEMS .

### BACKGROUND

Business entities issue a bond as a financial instrument of indebtedness of the bond issuer, namely the business entities, to the holders, namely other entities and individuals who purchase the bond. The bond is a debt security, under which the issuer owes the holders a debt and, depending on the terms of the bond, is obliged to pay them interest (the coupon) and/or to repay the principal at a later date, termed the maturity.

### BRIEF DESCRIPTION OF THE DRAWINGS

The accompanying appendices and/or drawings illustrate various non-limiting, example, inventive aspects in accordance with the present disclosure:

FIG. 1A is of a block diagram illustrating data flow between a ACRLMP system and affiliated entities in one embodiment of the ACRLMP;

FIG. 1B is of a work flow diagram illustrating work flow between various ACRLMP related entities for issuance of a ACRLMP instrument to fund municipal life insurance policies, according to one embodiment of the ACRLMP;

FIGS. 2A-2B provide data analytics diagrams and/or plots illustrating example projected performance of the ACRLMP program, according to one embodiment of the ACRLMP;

FIGS. 3A-3D provide example data analytics diagrams illustrating state financial conditions, according to one embodiment of the ACRLMP; and

FIG. 4 is of a block diagram illustrating embodiments of the ACRLMP controller;

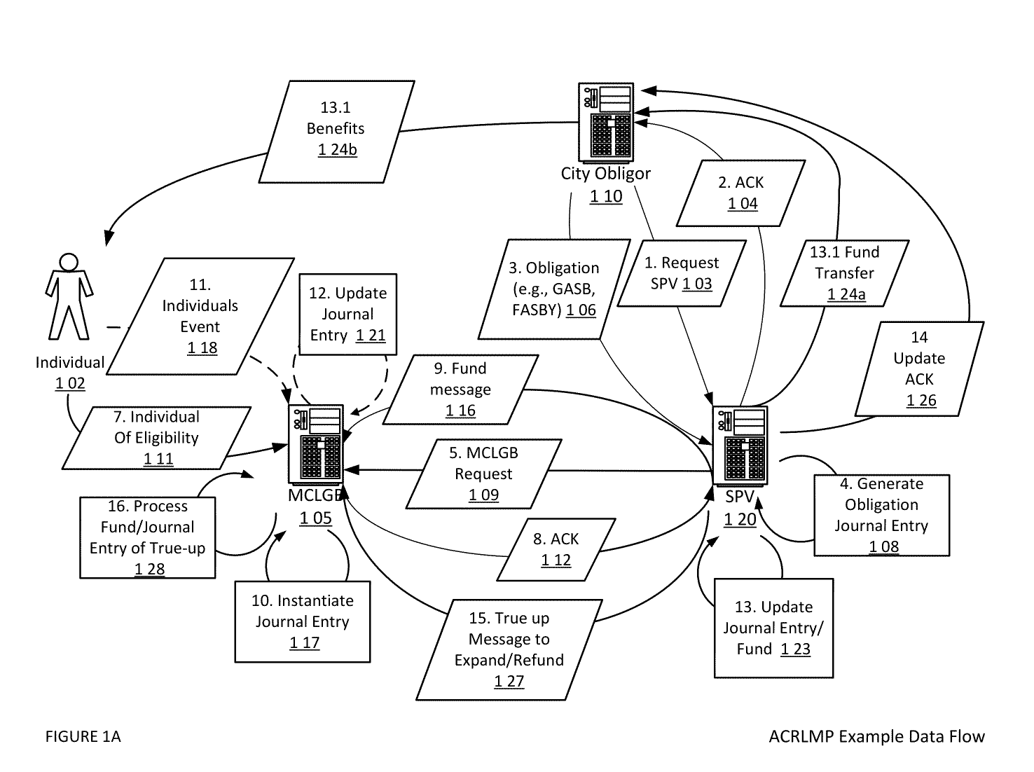

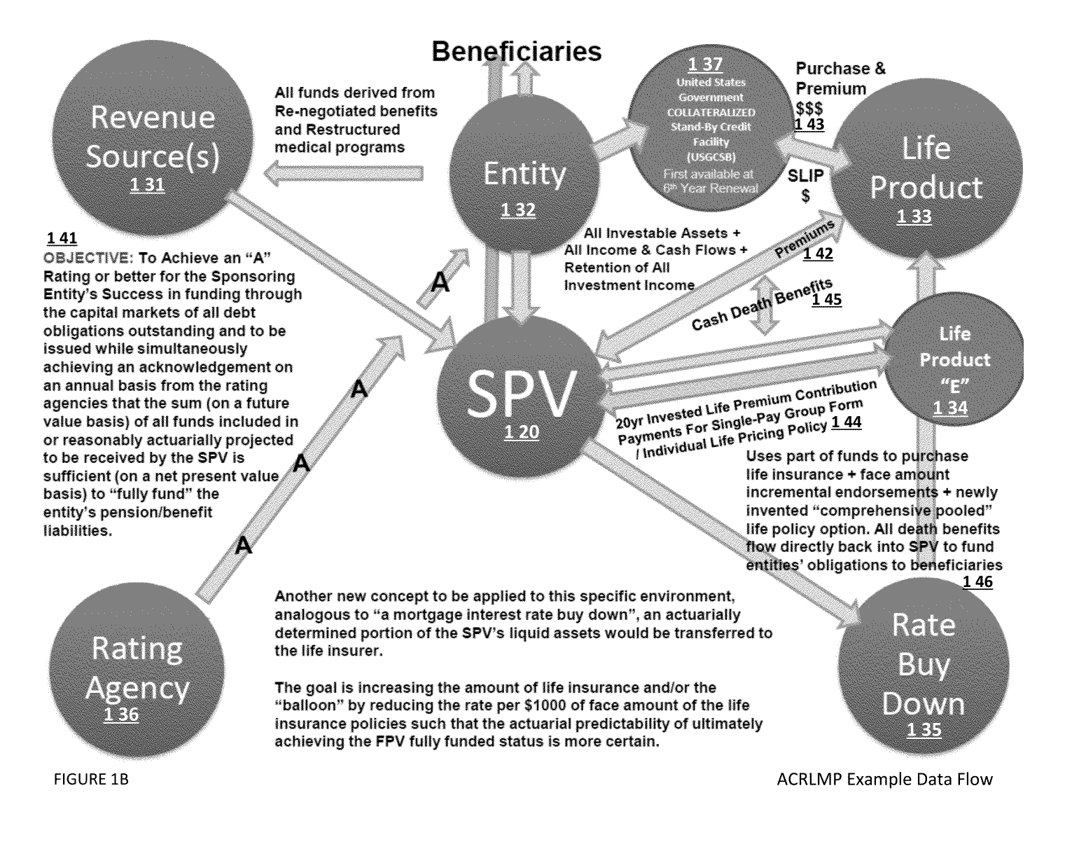

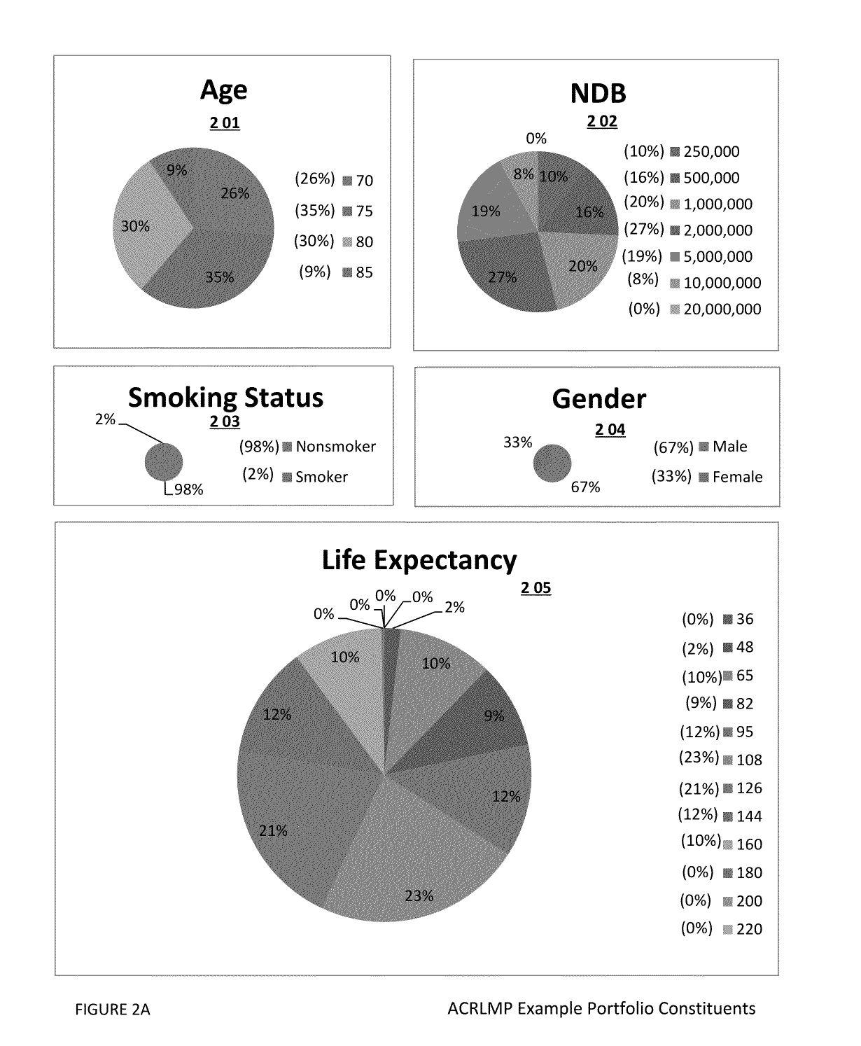

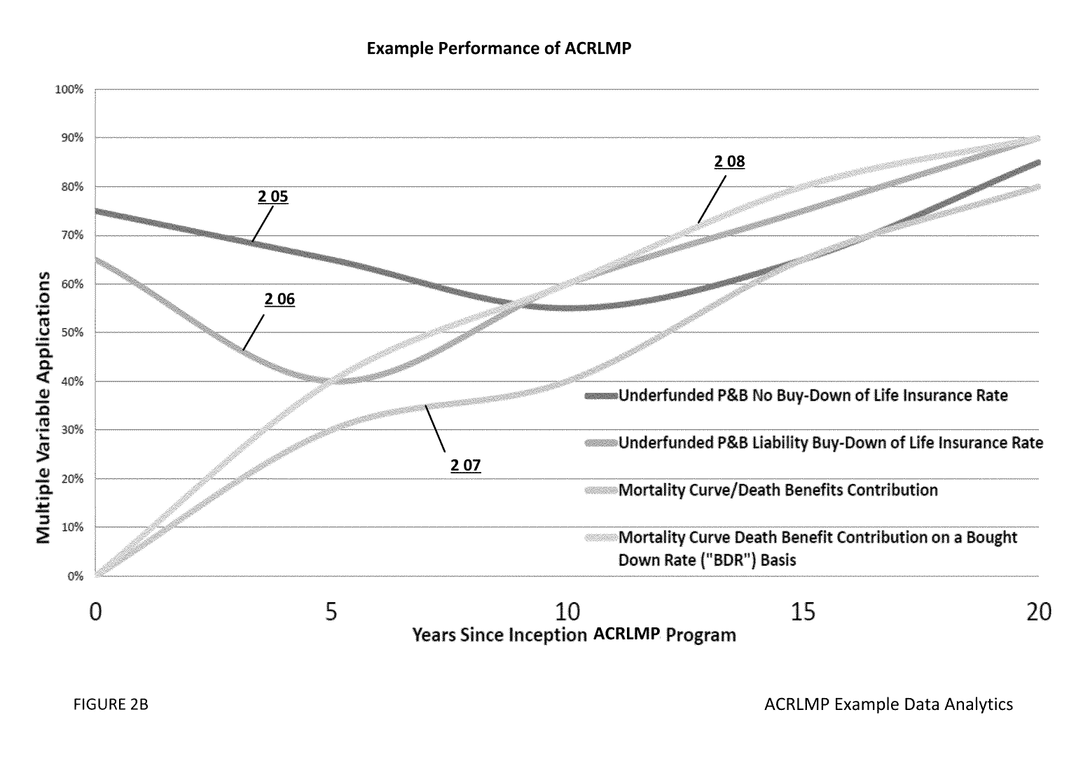

The leading number of each reference number within the drawings such, a detailed discussion of reference number 101 would be found and/or introduced in FIG. 1. Reference number 201 is introduced in FIG. 2, etc.

### DETAILED DESCRIPTION

### ACRLMP

The ASSET COLLECTIVE REDIRECTION LEVERAGE MULTIPLIER PLATFORM APPARATUSES, METHODS AND SYSTEMS (“ACRLMP”) provide a financial instrument management platform facilitating issuance, transaction, interest payment, and/or analytics of a municipality-based liquidity instrument from municipalities, investors, and sponsors. In one implementation, the ACRLMP may create municipality-based financial instrument to leverage and/or multiply funds among various entities such as municipal entities, beneficiaries of municipal sponsored life insurance policies, revenue sources, and/or the like, as further illustrated in FIG. 1B.

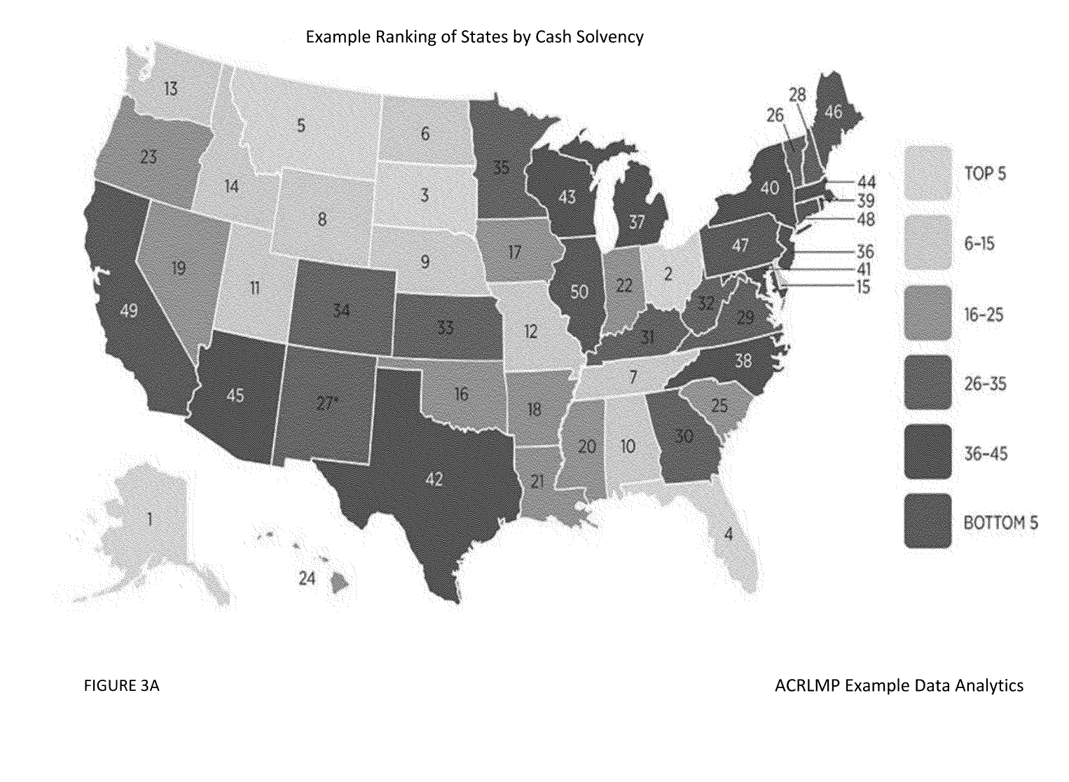

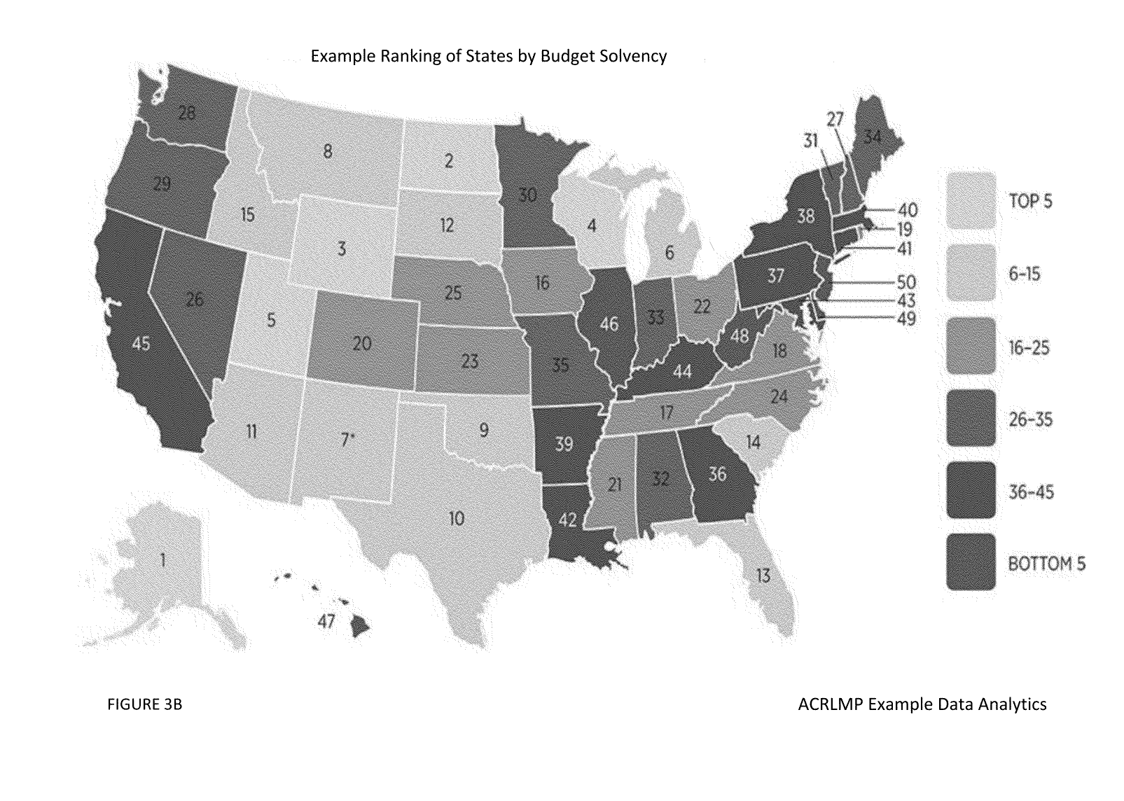

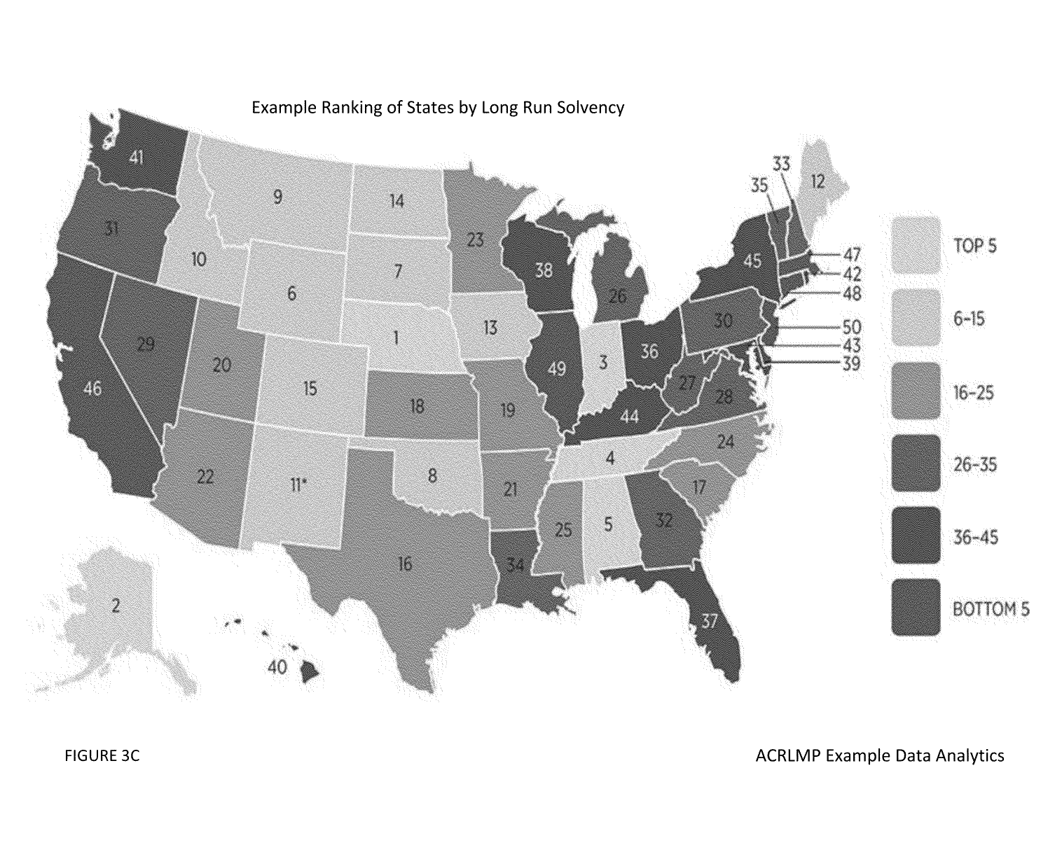

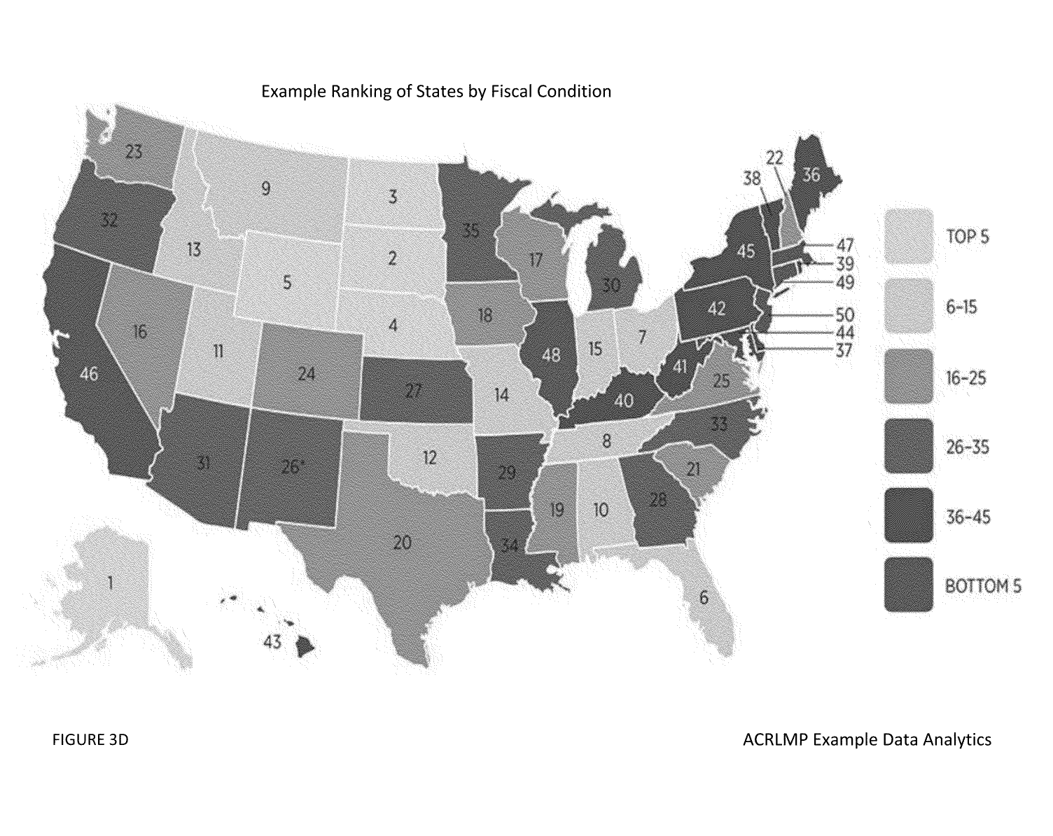

For example, in one implementation, many cities in the United States may be under insured, and may face policy increase on real estate taxes. In one implementation, the city municipality may be under debts, and may improve the debt situation by a number of ways, e.g., pure magnitude (e.g., raise more money, etc.), insurable interests (e.g., buying insurance for government employees in compliance with regulations, etc.), liquidity (e.g., life settlement, etc.), and/or the like. In this case, the unfunded and/or under-funded pension and related benefits crisis may confront states, cities, counties, pensions and/or other benefit providers, which may create a liability exposure to the municipality. As no reasonable mechanism either by construct or by acceptability of reduction of the previously contractually granted benefits has yet been validated, resorting to the option of bankruptcy remains the sole comprehensive option of most certain resolution and flexibility to deal with the crisis for municipalities and corporations. For example, FIGS. 3A-3D provide example data analytics illustrating example ranking of states financial condition, e.g., cash solvency per state as shown in FIG. 3A, budget solvency as shown in FIG. 3B, long run solvency as shown in FIG. 3C, fiscal condition as shown in FIG. 3D, and/or the like.

As another example, certain political entities (e.g., the State of Illinois, etc.) may have recognized that the level of benefits currently contractually committed present an impossible funding challenge. They may consider or have taken action to reduce benefits, either through negotiation or through mandated legislative change. In both cases, the reaction of the beneficiaries has been litigation of a substantial nature, either contractually or constitutionally. However, bankruptcy resolution or forced benefit reductions may incur economic and moral implications on various aspects of the political entity, such as but not limited to an effect on State's credit rating under new GASBY Accounting Rules, effect on State's ability to access capital markets for future funding needs, both G.O. and specific utilization bonds (including State's current, existing bond(s) pricing in capital markets, State's competitive perception in soliciting new economic development funding from both private and public sector, State's need to tax and charge fees to make up budget shortfalls and generate operating and debt-service revenues, etc.), effect on political, social & moral stability, effect on community growth, preservation, and future economic development versus accelerated deterioration and abandonment, effect on employment opportunity and growth, economic uncertainty in the view of capital markets, worker and Voter resistance, and its effect on litigation volume and costs, and/or the like.

In one implementation, the ACRLMP may consist of currently funded and predictable future cash inflows to the “sponsor” minus negotiated benefit reductions actuarially constructed to represent those acceptable savings required for the process and products to achieve investment grade ratings for the sponsors on a future value basis within 15-20 years. The utilization of life insurance under a new policy form currently under construction, either term or a hybrid of a cash value and term T-100 policy, in combination with the other factors can achieve acceptable pension funding adequacy on an actuarially acceptable, future-present value basis within the projected time frames, and provide the new negotiated benefits funding obligations for the sponsor.

In addition, the ability to use supplemental products with no negative principal potential such as Index Products, Cash-Value Building Options, etc.—provide the ability to compound the amount of cash available to a special purpose vehicle (SPV), to meet the entity's cash obligations through a variety of economic investment cycles.

In one implementation, the ACRLMP may calculate projected ACRLMP benefits according to the following formula:

(Current Funded Capacity (Allocated per Variables Included in ACRLMP Algorithm)+Reasonably Predictable Future Predictable Cash In Flows+(Reasonable Future Investment Income Assumptions) (Negotiated Benefit Reductions)−(Cash Outflows to pay Benefits & Life Insurance Premiums)+Actuarially Constructed, Future Death Benefit Receipts from the Life Insurance Product(s) according to a conservatively applied Mortality Curve Assumption unique to the Beneficiary Population)+(Mathematically & Actuarially Calculated Cash Proceeds derived from inception +20 year acquired Life-Benefit Reduction Policy)=Acceptably Funded Actuarial Benefit & Payment Obligations within 15-20 Years Discounted by a Historically Modeled Discount Rate, on a Future Value Basis

Or alternatively, the factors above may satisfy the following:

(A₁+A₂+A₃)+B−(C*)+D**≧75%+E***

wherein A1 denotes currently funded capacity, A2 denotes achievable future predictable cash in-flows, A3 denotes predictable future investment income under a reasonable future interest rate assumption, B denotes negotiated benefit reductions, C denotes cash outflows to pay benefits and/or life insurance premiums, D denotes actuarially constructed future death benefit receipts from the life insurance product(s), and E denotes supplemental actuarially & mathematically determined benefit recovery group-priced/individually owned single pay life policy purchased at program termination. Specifically, C may be obtained under an ACRLMP program designed to cover currently active employees; D may be obtained from conservative mortality curve predictability of death benefit receipts flowing through the construct of this Product to the clients entity to increase its cash on-hand for both investment, and benefit payment purposes. This will also affect the per-member face value of life insurance policies provided under a group, individual, or “blended” construction.

For example, if the city of Miami may need to fund their firefighters, police officers on healthcare benefits, etc., but only have limited financial resources to support such program, the municipality may create and issue a debt instrument based on mortality of the government employees who benefited from the program (e.g., employees of high risk units such as firefighters, police officers, etc.), e.g., a mortality curve liquidity guarantee bond (MCLGB) (or as another example, Mortality Curve Liquidity Performance Guarantee Bond (MCLPGB)) to raise funds to support their employees, e.g., purchase life insurance, etc. For example, in one implementation, in compliance with federal and state regulations, the municipality may create a trust serving as a gateway to an escrow account, e.g., a special purpose vehicle (SPV), etc., for the MCLGB transaction. For example, MCLGB may be a one year contractable financial document. In this way, the municipality may fund life insurance policies to their employees, e.g., firefighters, police, etc., via the MCLGB and SPV. One advantage is that premium insensitivity (as contrasted from premium indifference) may be employed to leverage unfunded obligations and to bridge same.

In one implementation, the MCLPGB may act as a performance guarantee bond for multiple beneficiaries, to with the premium finance company/funding agent-guarantor of the outstanding liabilities of the at risk, underfunded entities, the members of the P&H&W Plans (e.g., assuring up to 100% payment of their benefits under their existing plans), the guarantor, who is obligated to issue a one (i) year, guaranteed renewable, potentially (almost certainly) extendable and incremental dollar guarantee, assuring an ever growing (by both number of clients/cases, years to maturity, and dollar guarantee of liquidity obligation), with full actuarial and financial certainty of repayment, with agreed returns, of their, and the financier's, principal exposures. The MCLPGB issuer may assume escrowed, unassailable first right to their full principal and compound (Return of Investment) ROI position through a multilayer, unique legal structure, who may reserve the right to alter its contractual position with all parties annually, without objection, so long as the financier's rights and guarantees' are equally assured.

In a further implementation, the MCLPGB will advance liquidity to pay all obligations monthly, with an annual true-up of immediately available liquid collateral against advanced liquidity (including incurred and actuarially projected interest) each agreed upon calendar (12 month) period.

In the case of a shortfall in the actuarial predictability/performance of the security trust and/or escrow pool, the MCLPGB may accede to a primary, secured position in the as yet un-received liquidation of collateral, with multiple additional security guarantees, until the prior year's obligations to it are fulfilled. A new MCLPGB can be irrevocably issued in the interim for that succeeding twelve (12) month period, so long as an over-collateralized position (5:1 or more) exists in the secured, Trust, collateral pool.

In one implementation, the ACRLMP may employ a financial structure that allows variable premium rate buy-down with correlated and/or collared investment rate. For example, the ACRLMP program, which is analogous to a mortgage-rate buy-down program, may allow the SPV to utilize some of its initial and ongoing, incoming cash flows to “buy-down” the Life Insurance Premium Rate so as to increase to the maximum allowable face amount of the collateral life insurance policies; thereby in effect accelerating the Mortality Curve by generating substantially more dollars even at a slower Mortality Curve effective rate. Each application can be specifically applied to the beneficiary census and historical mortality curve history as well as the interest rate environment.

In one implementation, the ACRLMP may have the potential for creation of federal two or three year premium liquidity guarantee securitized by selected stochastic life insurance pool, modeled against a conservative mortality curve of “3 to 5×1” of over-collateralization rate of death benefits, to liquidity line utilization proposed at 2× treasury borrowing rate for drawn funds.

In one implementation, the ACRLMP may include the creation of “Umbrella Group/Individual” life policy application to provide substantial additional death benefit support to provide additional cash flow support to benefit payments requirements of sponsoring client entity, e.g., on individual grouped basis, on group-individual basis, on hybrid construction, and/or the like.

In one implementation, the ACRLMP may include the creation of new life insurance product construct, a modified application with new filings of yearly renewable term (YRT) rising premium, level term, annual term or potential blended modification of above, a “Put/Call” on policy purchase and issuance at loth year and 1st day—death proceeds payable immediately; life proceeds payable as deaths occur (premium contributions continue pro-rata on living members), a base face amount & premium established at inception; actual face amount determined by existing premium on “Put/Call” date, non-payment proceeds accrued (as are annual contributory premium payments towards purchase date at agreed collared floating rate investment percentage), benefits that are paid tax-free to the members' families subject to applicable costs and fees, and/or the like.

In one implementation, the ACRLMP may provide premium finance construct opportunities, including interests only for “X” years, semi-amortizing for “Y” years, fully-amortizing for “Z” years, balloon loan financing model partially-amortizing for “X” years, collateralized balloon at term-end, being fully amortizing, and/or the like.

In further implementations, the ACRLMP may include variable premium payment scenarios, supplemental cash-generating endorsements, policy forms, annual certification by independent actuaries and/or benefit plan experts as to prior-year and next two years of predictable achievement of planned success factors (e.g., these certifications may be completed by the senior executive politician, the senior executive financial officer and the plan manager of the sponsoring entity, etc.), historical cyclicality in investment income environment over 20 year period, and/or the like.

FIG. 1A shows a data flow diagram illustrating data flow between an ACRLMP system and affiliated entities in one embodiment of the ACRLMP. In FIG. 1, one or more individuals 102, a MLGB component 105, a SPV component 120, a city obligor 110, and/or the like are shown to interact via a communication network. In one implementation, the variety of entities may communicate via a wide variety of different communications devices and technologies within embodiments of ACRLMP operation. For example, in one embodiment, the individuals 102, MLCGB component 105, SPV component 120, and/or city obligor 110 may include, but are not limited to, terminal computers, work stations, servers, cellular telephony handsets, smartphones, PDAs, and/or the like. In one embodiment, the communication network 113 may comprise, but not is not necessarily limited to local area network (LAN), in-house intranet, the Internet, and/or the like.

In one embodiment, a city obligor 110 may send a request to the SPV management platform 120 to request a SPV 103 (e.g., to create a SPV), which may include a percentage of insurance interests and may be over collateralized. In one implementation, the SPV 120 may be created and in turn return an acknowledgement message 104 to the city obligor 110. The city obligor 110 may then provide obligation information (e.g., compliance with the government accounting standards board (GASB), financial accounting standards board (FASB), etc.) 106 to the SPV 120.

In one implementation, the SPV may generate obligation journal entry 108 for storage and regulation, etc. In one implementation, the SPV 120 may generate a MCLGB request 109 to the MCLGB component 105 to create the MCLGB bond, wherein such request may include the special vehicle information, face amount, a term, and/or the like. An example listing of the MCLGB bond generation message 109, substantially in the form of a HTTP(S) POST message including XML-formatted data, is provided below:

POST /MLCGB-generation.php HTTP/1.1
Host: www.ACRLMP-spv.com
Content-Type: Application/XML
Content-Length: 867
<?XML version = “1.0” encoding = “UTF-8”?>
< MLCGB-generation>

<bond_id> 4SDASDCHUF \hat{ }GD& </bond_id>
<timestamp> 2014-01-22 15:22:44</timestamp>
<program>

<term> 1 year </term>
<principal> 1200.00 </principal>
<amount> 100,000 </amount>
<interest_rate> 5% </interest_rate>
<beneficiary_type> firefighter </beneficiary_type>
...

</program>
<SPV>

<account_type> escrow </account_type>
<account_no> 11111111111111 </account_no>
...

</SPV>
<municipality>

<city_id> NYWe </city_id>
<agency_id> 8889 </agency_id>
<insurance_type> life </insurance_type>
...

</municipality>
...

</true-up>

The MLCGB 105 may receive individual eligibility information in from an individual 102 (e.g., individuals participating in the life insurance program, etc.), and provide acknowledgement 112 to the SPV 120.

In one implementation, the MLCGB may pass on the acknowledgement message 112 to the SPV server 120, which may in turn generate a fund message 116 including details of the municipality funding program, e.g., amount, term, purpose, sponsored participants, etc.

In one implementation, the MLCGB may instantiate a journal entry 117, e.g., including individual profile information (e.g., employment, age, health information, financial status, etc.). If an individual event 118 occurs (e.g., casualty of the participating individuals, etc.), the MCLGB may update the journal entry 121, e.g., by updating the individual record as “deceased” and remove the life insurance of the corresponding individual participant.

In one implementation, the SPV 120 may in turn obtain the updated journal/fund information and update its journal entry accordingly 123.

In one implementation, the SPV 120 may generate a fund transfer message (e.g., the insurance benefits for casualty, etc.) 124a to the city obligor 110, which may in turn municipality programs 124b. Upon the payment, the SPV 120 may update the acknowledgment 126 with the city obligor no.

In one implementation, the SPV 120 may true-up with the MCLGB to expand and/or refund the contract 127 (e.g., annually, etc.). For example, the SPV 120 may generate a (Secure) Hypertext Transfer Protocol (“HTTP(S)”) POST message including a true-up message in the form of data formatted according to the XML. An example listing of true-up message 127, substantially in the form of a HTTP(S) POST message including XML-formatted data, is provided below:

POST /true-up.php HTTP/1.1
Host: www.ACRLMP-spv.com
Content-Type: Application/XML
Content-Length: 867
<?XML version = “1.0” encoding = “UTF-8”?>
<true-up>

<bond_id> 4SDASDCHUF \hat{ }GD& </bond_id>
<timestamp>2014-02-22 15:22:44</timestamp>
<program>

<term> 1 year </term>
<principal> 1200.00 </principal>
<amount> 100,000 </amount>
<interest_rate> 5% </interest_rate>
<beneficiary_type> firefighter </beneficiary_type>
...

</program>
<casualty_record>

<profile_1>
<individual_id> JS220 </individual_id>
<individual_name> John Smith </individual_name>
<casualty_date> 2013-12-29 </casualty_date>
...
</profile_1>
<profile_2>

...

</profile_2>
...

</casualty_record>
<amount_paid> 100,000 </amount_paid>
<true-up> 2000.00 </true-up>
...

</true-up>

FIG. 1B is of a work flow diagram illustrating work flow between various ACRLMP related entities (e.g., a SPV 120, the revenue resource(s) 131, an entity 132 and/or beneficiaries, government collateralized credit facility 137, rate buy down party 135, rating agency 136, and/or the like) for issuance of an ACRLMP instrument to fund municipal life insurance policies, according to one embodiment of the ACRLMP. In one implementation, the revenue source(s) 131 may have an objective 141 to achieve an “A” rating or better for a sponsoring entity's success in funding through the capital markets of all debt obligations outstanding and to be issued while simultaneously achieving an acknowledgement on an annual basis from the rating agencies that the sum (on a future value basis) of all funds included in or reasonably actuarially projected to be received by the SPV is sufficient (on a net present value basis) to “fully fund” the entity's pension/benefit liabilities.

In one implementation, the conventional life product 133 may be purchased and paid by a United States Government Collateralized Stand-By Credit Facility (USGCSB) 137, wherein the premiums 142 may flow to the SPV management platform 120. For example, the USGCSB 137 may pay the premium amount 143.

In another implementation, the SPV management platform 120 may create an “extra” life product 134, e.g., a 20 year invested life premium contribution payments for single-pay group from /individual life pricing policy 144. The rate-buy-down entity 135 may use part of the funds to purchase life insurance and a face amount incremental endorsements, a comprehensive pooled life policy option, and/or the like. All death benefits (e.g., 145) may directly flow back into SPV management platform 120 to fund the entities' (132) obligations to beneficiaries, e.g., at 146.

In a further implementation, the ACRLMP may adopt another new concept to be applied to this specific environment as shown in FIG. 1B, analogous to “a mortgage interest rate buy down”, an actuarially determined portion of the SPV's liquid assets would be transferred to the life insurer. The goal is to increase the amount of life insurance and/or the “balloon” by reducing the rate per $1000 of face amount of the life insurance policies such that the actuarial predictability of ultimately achieving the SPV fully funded status is more certain.

In this way, the ACRLMP may substantially mitigate a series of issues arising from the state funding crisis, such as A) question of insurable interest B) inability to invent additional funding through the use of life insurance C) ultimate determination of application of GASBY Accounting by rating agencies to the “entities” total comprehensive debt obligations including non-pension G.O., I.O., and other general state or municipal funding obligations has been resolved,; D) “reputational risk” to the life insurer; E) exclusion of existing retiree base and/or segregation of existing funds in “entity” for retired and current work force will at least be initially necessary; F) state and federal statute & regulation; G) political risk—both intra-entity and publicly elected; H) primary and re-insurance market capacity for face amount of necessary life insurance policies to address the magnitude of the liability; I) constitutional & state regulatory legislation protecting already-vested pension rights or already-retired beneficiaries.

FIGS. 2A-2B provide data analytics diagrams and/or plots illustrating example projected performance of the ACRLMP program, according to one embodiment of the ACRLMP. As show in FIG. 2A, an ACRLMP portfolio (of a population) may include mortalities based on various factors, such as age 201, net death benefit (NDB) 202, smoking status 203, gender 204, and/or the like, of a working population, based on which the ACRLMP may derive the life expectancy data 205. For example, an example portfolio description summary (as illustrated in FIG. 2A) may be provided similar to the following:

Policy Count 660

| | |
|---|---|
| Count | Percentage |

| | | |
|---|---|---|
| Age | | |
| 70 | 174 | 26% |
| 75 | 230 | 35% |
| 80 | 195 | 30% |
| 85 | 61 | 9% |
| Gender | | |
| Male | 445 | 67% |
| Female | 215 | 33% |
| Smoking Status | | |
| Nonsmoker | 647 | 98% |
| Smoker | 13 | 2% |
| NDB | | |
| 250,000 | 67 | 10% |
| 500,000 | 103 | 16% |
| 1,000,000 | 134 | 20% |
| 2,000,000 | 178 | 27% |
| 5,000,000 | 126 | 19% |
| 10,000,000 | 52 | 8% |
| 20,000,000 | | 0% |
| Life Expectancy | | |
| 36 | 0 | 0% |
| 48 | 12 | 2% |
| 65 | 69 | 10% |
| 82 | 62 | 9% |
| 95 | 82 | 12% |
| 108 | 151 | 23% |
| 126 | 136 | 21% |
| 144 | 81 | 12% |
| 160 | 65 | 10% |
| 180 | 2 | 0% |
| 200 | 0 | 0% |
| 220 | 0 | 0% |

FIG. 2B shows projected effect of the ACRLMP program of a population, including the underfunded P&B No buy-down of life insurance rate 205, underfunded P&B liability buy-down of life insurance rate 206, mortality curve/death benefits contribution 207, mortality curve death benefit contribution on a bought down rate (“BDR”) basis 208. It is understood that every case would be unique as to population, benefit funding levels, benefit funds accrued, need to modify the outflow of funds via certain cost constraint strategies, and the data plots in FIG. 2B is for illustrative purpose only.

For example, the premium reserve data may be similar to the following:

| % Program | (Interim | (Premium |
|---|---|---|
| Funded | Return) IRR | Reserve) PR |
| 1% | 9.99% | 106,263,543 |
| 5% | 10.83% | 95,952,238 |
| 10% | 11.28% | 87,619,716 |
| 25% | 12.04% | 75,538,619 |
| 50% | 12.74% | 63,613,856 |
| 75% | 13.71% | 50,869,668 |
| 90% | 14.66% | 38,029,995 |
| 95% | 15.21% | 31,260,982 |
| 99% | 16.31% | 21,162,721 |

As another example, the mortality results in 10 years may be similar to the following:

| % Program | Year 10 |
|---|---|
| Funded | Mortality |
| 1% | 49.09% |
| 5% | 50.61% |
| 10% | 51.36% |
| 25% | 52.58% |
| 50% | 53.94% |
| 75% | 55.30% |
| 90% | 56.52% |
| 95% | 57.12% |
| 99% | 58.48% |

As another example, the annual deaths data may be similar to the following:

| % Program | | | | | | | | | | |
|---|---|---|---|---|---|---|---|---|---|---|
| Funded | 1 | 2 | 3 | 4 | 5 | 6 | 7 | 8 | 9 | 10 |
| 1% | 19 | 21 | 24 | 22 | 31 | 30 | 47 | 37 | 48 | 45 |
| 5% | 10 | 17 | 22 | 36 | 47 | 36 | 36 | 46 | 40 | 44 |
| 10% | 13 | 18 | 25 | 42 | 36 | 40 | 34 | 45 | 52 | 34 |
| 25% | 14 | 26 | 32 | 30 | 36 | 36 | 42 | 39 | 43 | 49 |
| 50% | 15 | 14 | 31 | 33 | 44 | 42 | 48 | 51 | 43 | 35 |
| 75% | 15 | 17 | 32 | 29 | 35 | 37 | 50 | 52 | 58 | 40 |
| 90% | 2 | 27 | 25 | 38 | 43 | 38 | 46 | 44 | 64 | 46 |
| 95% | 9 | 19 | 28 | 48 | 40 | 51 | 50 | 44 | 49 | 39 |
| 99% | 11 | 16 | 22 | 43 | 60 | 50 | 53 | 41 | 46 | 44 |

As another example, the underfunded P&B liability (206) and the mortality curve data (207) in 20 years, may be similar to the following:

| | Underfunded P&B | Mortality Curve/Death |
|---|---|---|
| Years | Liability | Benefits Contribution |
| 0 | 65% | 0% |
| 5 | 40% | 10% |
| 10 | 50% | 50% |
| 15 | 75% | 75% |
| 20 | 100% | 100% |

ACRLMP Controller

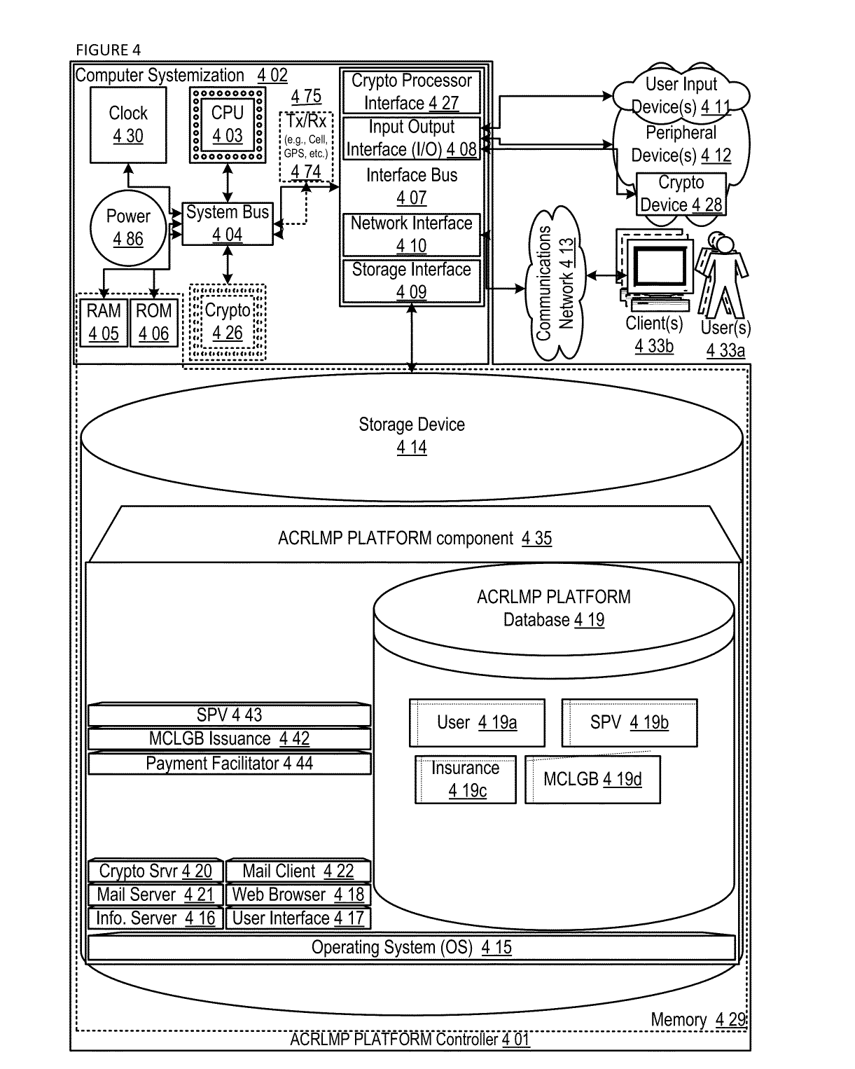

FIG. 4 shows a block diagram illustrating embodiments of a ACRLMP controller. In this embodiment, the ACRLMP controller 401 may serve to aggregate, process, store, search, serve, identify, instruct, generate, match, and/or facilitate interactions with a computer through social network and electronic commerce technologies, and/or other related data.

Typically, users, which may be people and/or other systems, may engage information technology systems (e.g., computers) to facilitate information processing. In turn, computers employ processors to process information; such processors 403 may be referred to as central processing units (CPU). One form of processor is referred to as a microprocessor. CPUs use communicative circuits to carry and pass encoded (e.g., binary) signals acting as instructions to bring about various operations. These instructions may be operational and/or data instructions containing and/or referencing other instructions and data in various processor accessible and operable areas of memory 429 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the ACRLMP controller 401 may be connected to and/or communicate with entities such as, but not limited to: one or more users from user input devices 411; peripheral devices 412; an optional cryptographic processor device 428; and/or a communications network 413.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The ACRLMP controller 401 may be based on computer systems that may comprise, but are not limited to, components such as: a computer systemization 402 connected to memory 429.

### Computer Systemization

A computer systemization 402 may comprise a clock 430, central processing unit (“CPU(s)” and/or “processor(s)” (these terms are used interchangeable throughout the disclosure unless noted to the contrary)) 403, a memory 429 (e.g., a read only memory (ROM) 406, a random access memory (RAM) 405, etc.), and/or an interface bus 407, and most frequently, although not necessarily, are all interconnected and/or communicating through a system bus 404 on one or more (mother)board(s) 402 having conductive and/or otherwise transportive circuit pathways through which instructions (e.g., binary encoded signals) may travel to effectuate communications, operations, storage, etc. The computer systemization may be connected to a power source 486; e.g., optionally the power source may be internal. Optionally, a cryptographic processor 426 and/or transceivers (e.g., ICs) 474 may be connected to the system bus. In another embodiment, the cryptographic processor and/or transceivers may be connected as either internal and/or external peripheral devices 412 via the interface bus I/O. In turn, the transceivers may be connected to antenna(s) 475, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing ACRLMP controller to determine its location)); Broadcom BCM4329FKUBG transceiver chip (e.g., providing 802.11n, Bluetooth 2.1+ EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 429 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the ACRLMP controller and beyond through various interfaces. Should processing requirements dictate a greater amount speed and/or capacity, distributed processors (e.g., Distributed ACRLMP), mainframe, multi-core, parallel, and/or super-computer architectures may similarly be employed.Alternatively, should deployment requirements dictate greater portability, smaller Personal Digital Assistants (PDAs) may be employed.

Depending on the particular implementation, features of the ACRLMP may be achieved by implementing a microcontroller such as CAST's R8051XC2 microcontroller; Intel's MCS 51 (i.e., 8051 microcontroller); and/or the like. Also, to implement certain features of the ACRLMP, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the ACRLMP component collection (distributed or otherwise) and/or features may be implemented via the microprocessor and/or via embedded components; e.g., via ASIC, coprocessor, DSP, FPGA, and/or the like. Alternately, some implementations of the ACRLMP may be implemented with embedded components that are configured and used to achieve a variety of features or signal processing.

Depending on the particular implementation, the embedded components may include software solutions, hardware solutions, and/or some combination of both hardware/software solutions. For example, ACRLMP features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the ACRLMP features. A hierarchy of programmable interconnects allow logic blocks to be interconnected as needed by the ACRLMP system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the ACRLMP may be developed on regular FPGAs and then migrated into a fixed version that more resembles ASIC implementations. Alternate or coordinating implementations may migrate ACRLMP controller features to a final ASIC instead of or in addition to FPGAs. Depending on the implementation all of the aforementioned embedded components and microprocessors may be considered the “CPU” and/or “processor” for the ACRLMP.

### Power Source

The power source 486 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 486 is connected to at least one of the interconnected subsequent components of the ACRLMP thereby providing an electric current to all subsequent components. In one example, the power source 486 is connected to the system bus component 404. In an alternative embodiment, an outside power source 486 is provided through a connection across the I/O 408 interface. For example, a USB and/or IEEE 1394 connection carries both data and power across the connection and is therefore a suitable source of power.

### Interface Adapters

Interface bus(ses) 407 may accept, connect, and/or communicate to a number of interface adapters, conventionally although not necessarily in the form of adapter cards, such as but not limited to: input output interfaces (I/O) 408, storage interfaces 409, network interfaces 410, and/or the like. Optionally, cryptographic processor interfaces 427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 409 may accept, communicate, and/or connect to a number of storage devices such as, but not limited to: storage devices 414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 410 may accept, communicate, and/or connect to a communications network 413. Through a communications network 413, the ACRLMP controller is accessible through remote clients 433b (e.g., computers with web browsers) by users 433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed ACRLMP), architectures may similarly be employed to pool, load balance, and/or otherwise increase the communicative bandwidth required by the ACRLMP controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 410 may be used to engage with various communications network types 413 For example, multiple network interfaces may be employed to allow for the communication over broadcast, multicast, and/or unicast networks.

Input Output interfaces (I/O) 408 may accept, communicate, and/or connect to user input devices 411, peripheral devices 412, cryptographic processor devices 428, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x, Bluetooth, cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 411 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 412 may be connected and/or communicate to I/O and/or other facilities of the like such as network interfaces, storage interfaces, directly to the interface bus, system bus, the CPU, and/or the like. Peripheral devices may be external, internal and/or part of the ACRLMP controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the ACRLMP controller may be embodied as an embedded, dedicated, and/or monitor-less (i.e., headless) device, wherein access would be provided over a network interface connection.

Cryptographic units such as, but not limited to, microcontrollers, processors 426, interfaces 427, and/or devices 428 may be attached, and/or communicate with the ACRLMP controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 429. However, memory is a fungible technology and resource, thus, any number of memory embodiments may be employed in lieu of or in concert with one another. It is to be understood that the ACRLMP controller and/or a computer systemization may employ various forms of memory 429. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 429 will include ROM 406, RAM 405, and a storage device 414. A storage device 414 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 429 may contain a collection of program and/or database components and/or data such as, but not limited to: operating system component(s) 415 (operating system); information server component(s) 416 (information server); user interface component(s) 417 (user interface); Web browser component(s) 418 (Web browser); database(s) 419; mail server component(s) 421; mail client component(s) 422; cryptographic server component(s) 420 (cryptographic server); the ACRLMP component(s) 435; and/or the like (i.e., collectively a component collection). These components may be stored and accessed from the storage devices and/or from storage devices accessible through an interface bus. Although non-conventional program components such as those in the component collection, typically, are stored in a local storage device 414, they may also be loaded and/or stored in memory such as: peripheral devices, RAM, remote storage facilities through a communications network, ROM, various forms of memory, and/or the like.

### Operating System

The operating system component 415 is an executable program component facilitating the operation of the ACRLMP controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with communications networks, data, I/O, peripheral devices, program components, memory, user input devices, and/or the like. The operating system may provide communications protocols that allow the ACRLMP controller to communicate with other entities through a communications network 413. Various communication protocols may be used by the ACRLMP controller as a subcarrier transport mechanism for interaction, such as, but not limited to: multicast, TCP/IP, UDP, unicast, and/or the like.

### Information Server

An information server component 416 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the ACRLMP controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the ACRLMP database 419, operating systems, other program components, user interfaces, Web browsers, and/or the like.

Access to the ACRLMP database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the ACRLMP. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the ACRLMP as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 417 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 418 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the ACRLMP enabled nodes. The combined application may be nugatory on systems employing standard Web browsers.

### Mail Server

A mail server component 421 is a stored program component that is executed by a CPU 403. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the ACRLMP.

Access to the ACRLMP mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 422 is a stored program component that is executed by a CPU 403. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 420 is a stored program component that is executed by a CPU 403, cryptographic processor 426, cryptographic processor interface 427, cryptographic processor device 428, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the ACRLMP may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the ACRLMP component to engage in secure transactions if so desired. The cryptographic component facilitates the secure accessing of resources on the ACRLMP and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The ACRLMP Database

The ACRLMP database component 419 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the ACRLMP database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the ACRLMP database is implemented as a data-structure, the use of the ACRLMP database 419 may be integrated into another component such as the ACRLMP component 435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 419 includes several tables 419a-d. A User table 419a includes fields such as, but not limited to: consumer_name, consumer_age, consumer_sex, consumer address, consumer_income, consumer_demo, consumer automobile, consumer_insurnace, and/or the like. The User table may support and/or track multiple entity accounts on a ACRLMP. A SPV table 419b includes fields such as, but not limited to: SPV_type, SPV_no, SPV_id, SPV account_number, SPV_status, and/or the like. An Insurance table 419c may include fields such as, but not limited to insurance_type, insurance_time, Insurance_payment, insurance_premium, insurance eligibility, and/or the like. A MLCGB table 419d includes fields such as, but not limited to: MCLGB_ID, MCLGB_Name, MCLGB_term, MCLGB_interest, MCLGB_face_amount, MCLGB_parties, MCLGB_price, and/or the like.

In one embodiment, the ACRLMP database may interact with other database systems. For example, employing a distributed database system, queries and data access by search ACRLMP component may treat the combination of the ACRLMP database, an integrated data security layer database as a single database entity.

In one embodiment, user programs may contain various user interface primitives, which may serve to update the ACRLMP. Also, various accounts may require custom database tables depending upon the environments and the types of clients the ACRLMP may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 419a-d. The ACRLMP may be configured to keep track of various settings, inputs, and parameters via database controllers.

The ACRLMP database may communicate to and/or with other components in a component collection, including itself, and/or facilities of the like. Most frequently, the ACRLMP database communicates with the ACRLMP component, other program components, and/or the like. The database may contain, retain, and provide information regarding other nodes and data.

### The ACRLMPs

The ACRLMP component 435 is a stored program component that is executed by a CPU. In one embodiment, the ACRLMP component incorporates any and/or all combinations of the aspects of the ACRLMP that was discussed in the previous figures. As such, the ACRLMP affects accessing, obtaining and the provision of information, services, transactions, and/or the like across various communications networks.

The ACRLMP transforms municipality agency information via ACRLMP components, such as SPV 243, MCLGB 242, payment facilitator 244 and/or the like into a MCLGB transaction output and match-up premium payment transactions.

The ACRLMP component facilitates access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the ACRLMP server employs a cryptographic server to encrypt and decrypt communications. The ACRLMP component may communicate to and/or with other components in a component collection, including itself, and/or facilities of the like. Most frequently, the ACRLMP component communicates with the ACRLMP database, operating systems, other program components, and/or the like. The ACRLMP may contain, communicate, generate, obtain, and/or provide program component, system, user, and/or data communications, requests, and/or responses.

### Distributed ACRLMPs

The structure and/or operation of any of the ACRLMP node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the ACRLMP controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c -post http://. . . Value1

where Valuei is discerned as being a parameter because “http://” is part of the grammar syntax, and what follows is considered part of the post value. Similarly, with such a grammar, a variable “Valuei” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the ACRLMP controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm
.IBMDI.doc/referenceguide295.htm

and other parser implementations:

http://publib.boulder.ibm.com/infocenter/tivihelp/v2r1/index.jsp?topic=/com.ibm
.IBMDI.doc/referenceguide259.htm

all of which are hereby expressly incorporated by reference.

In order to address various issues and advance the art, the entirety of this application for ASSET COLLECTIVE REDIRECTION LEVERAGE MULTIPLIER PLATFORM APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a ACRLMP individual and/or enterprise user, database configuration and/or relational model, data type, data transmission and/or network framework, syntax structure, and/or the like, various embodiments of the ACRLMP, may be implemented that facilitates a great deal of flexibility and customization. While various embodiments and discussions of the ACRLMP have been directed to social networks, however, it is to be understood that the embodiments described herein may be readily configured and/or customized for a wide variety of other applications and/or implementations.

What is claimed is:

1. A municipality-based debt instrument management system, comprising:
a memory;
a processor disposed in communication with said memory, and configured to issue a plurality of processing instructions stored in the memory, wherein the processor issues instructions to:
receive an indication of an individual participating in an insurance program;
verify the individual is eligible for a municipality-based instrument program provided by a third party;
determine a non-individualized insurance premium for the insurance program associated with the individual;
facilitate payment of the determined non-individualized insurance premium by the third party to an insurance provider; and
adjust the facilitated payment with the insurance provider based on a comparison of the non-individualized insurance premium and an individualized insurance premium.

2. The apparatus of claim 1 wherein the processor issues instructions to create a mortality curve liquidity guaranteed bond.

3. The apparatus of claim 1 wherein the determined non-individualized insurance premium is determined within a premium insensitive threshold.

4. The apparatus of claim 1, wherein the non-individualized insurance premium is determined based on life expectancy.

5. The apparatus of claim 4, wherein the life expectancy is determined based on age, demographics, smoking status information of a population.

6. The apparatus of claim 1, wherein the processor further issues instructions to advance liquidity to pay obligations periodically under the municipality-based instrument program with an annual true-up of immediately available liquid collateral against advanced liquidity in each agreed upon calendar period.

7. The apparatus of claim 1, wherein the processor further issues instructions to purchase any of a life insurance, a face amount incremental endorsement, and a life policy option.

8. The apparatus of claim 1, wherein the processor further issues instructions to use death benefits to fund municipal obligations to beneficiaries.

9. A municipality-based debt instrument management processor-readable non-transitory storage medium storing processor-executable instructions issuable by a processor to:
receive an indication of an individual participating in an insurance program;
verify the individual is eligible for a municipality-based instrument program provided by a third party;
determine a non-individualized insurance premium for the insurance program associated with the individual;
facilitate payment of the determined non-individualized insurance premium by the third party to an insurance provider; and
adjust the facilitated payment with the insurance provider based on a comparison of the non-individualized insurance premium and an individualized insurance premium.

10. The medium of claim 9 wherein the processor issues instructions to create a mortality curve liquidity guaranteed bond.

11. The medium of claim 9 wherein the determined non-individualized insurance premium is determined within a premium insensitive threshold.

12. The medium of claim 9, wherein the non-individualized insurance premium is determined based on life expectancy.

13. The medium of claim 9, wherein the life expectancy is determined based on age, demographics, smoking status information of a population.

14. The medium of claim 9, wherein the processor further issues instructions to advance liquidity to pay obligations periodically under the municipality-based instrument program with an annual true-up of immediately available liquid collateral against advanced liquidity in each agreed upon calendar period.

15. The medium of claim 9, wherein the processor further issues instructions to purchase any of a life insurance, a face amount incremental endorsement, and a life policy option.

16. The medium of claim 9, wherein the processor further issues instructions to use death benefits to fund municipal obligations to beneficiaries.

17. A municipality-based debt instrument management processor-implemented method, comprising:
receiving an indication of an individual participating in an insurance program;
verifying the individual is eligible for a municipality-based instrument program provided by a third party;
determining a non-individualized insurance premium for the insurance program associated with the individual;
facilitating payment of the determined non-individualized insurance premium by the third party to an insurance provider; and
adjusting the facilitated payment with the insurance provider based on a comparison of the non-individualized insurance premium and an individualized insurance premium.

18. The method of claim 17, wherein the processor issues instructions to create a mortality curve liquidity guaranteed bond.

19. The method of claim 17, wherein the determined non-individualized insurance premium is determined within a premium insensitive threshold.

20. The method of claim 17, wherein the non-individualized insurance premium is determined based on life expectancy.
